(19) United States
(12) Patent Application Publication
(10) Pub. No.: US 2008/0065391 A1
(43) Pub. Date: Mar. 13, 2008

(54) INPUT OPERATION SUPPORT APPARATUS AND CONTROL METHOD THEREFOR

(75) Inventor: Hiromi Omi, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/848,338

(22) Filed: Aug. 31, 2007

(30) Foreign Application Priority Data
Sep. 11, 2006 (JP) 2006-246136

(51) Int. Cl. G10L 21/00

(52) U.S. Cl. 704/275; 704/500

(57) ABSTRACT

An input operation support apparatus which improves user friendliness and comfort by properly controlling a voice guide output along with an operation input from the user is provided. In the input operation support apparatus having a speech output unit which outputs a voice message corresponding to an input operation to an operation unit, a detection unit detects an input operation to the operation unit. When the detection unit detects the second input operation within a predetermined time after the first input operation, a control unit restricts output of a voice message corresponding to the second input operation from the speech output unit.

### BACKGROUND OF THE INVENTION

1. Field of the Invention

The present invention relates to an input operation support apparatus having a speech output unit which outputs a voice message corresponding to an input operation to an operation unit, and a control method therefor.

2. Description of the Related Art

As a popular useful method, there is known a method of guiding information on the screen and operation contents by voice in accordance with a user's input operation. This method allows a user to confirm the information and operation contents visually and also aurally. When, however, the user successively performs a plurality of input operations within a short time, only the beginnings of voice messages corresponding to the respective input operations are sequentially output at a short interval. It is difficult for the user to clearly catch these messages.

To solve this problem, there is proposed a method of changing the speech output time on the basis of the user's input speed (e.g., Japanese Patent Laid-Open No. 61-267117). There is also proposed a method of outputting short and long voice messages stepwise on the basis of the user's input interval (e.g., Japanese Patent Laid-Open No. 2002-229714).

According to the technique as disclosed in Japanese Patent Laid-Open No. 61-267117, as the user increases the input speed, the voice message speed also increases, making the voice message understandable regardless of the input speed. According to the technique as disclosed in Japanese Patent Laid-Open No. 2002-229714, even if the user inputs operations within a short interval, he can grasp input items from short voice messages, and after waiting for a long time, can grasp detailed items from long voice messages. However, if the user performs operations at a short interval and need not grasp an intermediate voice message, he may feel annoyed with such a voice message. Japanese Patent Laid-Open Nos. 61-267117 and 2002-229714 do not consider this situation.

### SUMMARY OF THE INVENTION

It is an object of the present invention to improve user friendliness and comfort by properly controlling a voice message output along with an operation input from the user.

According to one aspect of the present invention, an input operation support apparatus having a speech output unit which outputs a voice message corresponding to an input operation to an operation unit is provided. In the apparatus, a detection unit detects an input operation to the operation unit. When the detection unit detects the second input operation within a predetermined time after the first input operation, a control unit restricts output of a voice message corresponding to the second input operation from the speech output unit.

Further features of the present invention will become apparent from the following description of exemplary embodiments with reference to the attached drawings.

### BRIEF DESCRIPTION OF THE DRAWINGS

FIG. 1 is a perspective view showing the outer appearance of an image processing apparatus according to an embodiment;

FIG. 2 is a block diagram showing the arrangement of the image processing apparatus according to the embodiment;

FIG. 3 is a block diagram showing the hardware configuration of the control unit of the image processing apparatus according to the embodiment;

FIG. 4 is a view showing an arrangement of the operation unit of the image processing apparatus according to the embodiment;

FIGS. 5A and 5B are views showing examples of a paper setting window in the embodiment;

FIGS. 6 and 7 are views for explaining concrete examples of a speech output control process in the embodiment;

FIG. 8 is a flowchart showing a speech output control process by a speech controller in the embodiment;

FIG. 9 is a flowchart showing the first modification of the speech output control process in the embodiment;

FIG. 10 is a flowchart showing the second modification of the speech output control process in the embodiment;

FIG. 11 is a flowchart showing the third modification of the speech output control process in the embodiment;

FIG. 12 is a flowchart showing a modification of the speech output control process shown in FIG. 11; and

FIG. 13 is a flowchart showing another modification of the speech output control process shown in FIG. 11.

### DESCRIPTION OF THE EMBODIMENTS

Preferred embodiments of the present invention will be described in detail in accordance with the accompanying drawings. The present invention is not limited by the disclosure of the embodiments and all combinations of the features described in the embodiments are not always indispensable to solving means of the present invention.

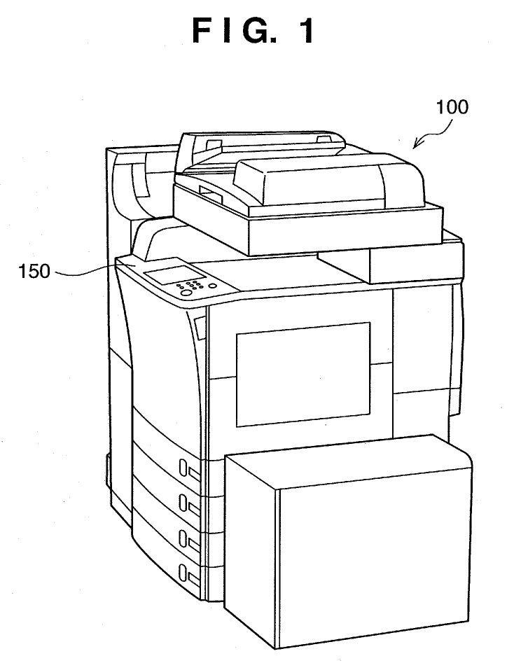

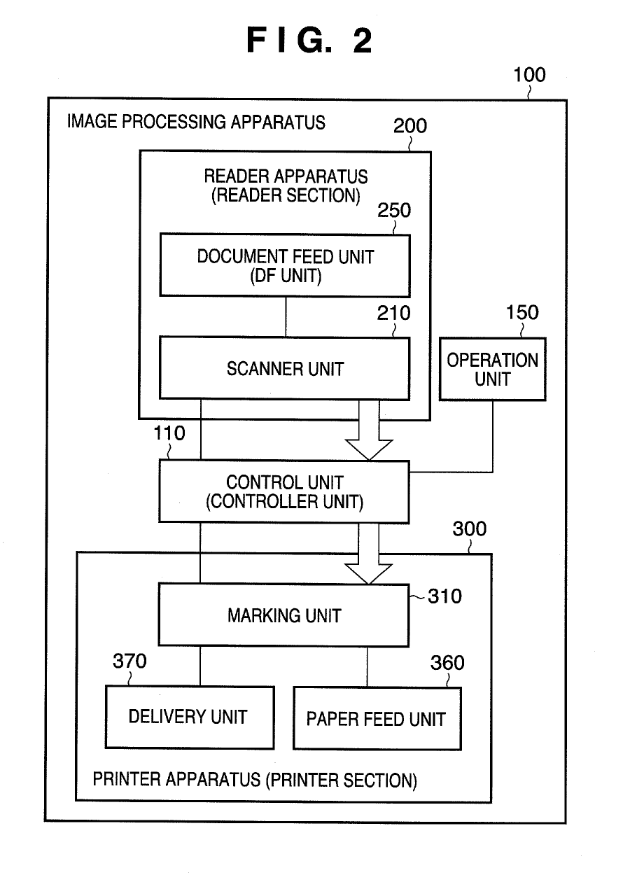

FIG. 1 is a perspective view showing the outer appearance of an image processing apparatus 100 to which an input operation support apparatus according to the present invention is applied. FIG. 2 is a block diagram showing the arrangement of the image processing apparatus 100.

The image processing apparatus 100 is a so-called multi-function peripheral which provides various image processing functions such as printing, image input, document filing, document transmission/reception, and image conversion. The image processing apparatus 100 is connected to, e.g., a LAN (not shown), and transmits/receives a document via the LAN. The image processing apparatus 100 also comprises a local interface (not shown) such as a USB interface or dedicated bus, and can communicate with a host computer or the like via the local interface. A reader section (image input apparatus) 200 optically reads a document image and converts it into image data. The reader section 200 comprises a scanner unit 210 having a function of scanning a document, and a document feed unit 250 having a function of feeding a document sheet.

A printer section (image output apparatus) 300 conveys printing paper, prints image data as a visible image on the printing paper, and delivers the printing paper outside the apparatus. In the printer section 300, a paper feed unit 360 has a plurality of types of printing paper cassettes. A marking unit 310 has a function of transferring and fixing image data onto printing paper. A delivery unit 370 has a function of sorting and stapling printed paper sheets, and outputting them outside the apparatus.

A control unit 110 is electrically connected to the reader section 200, the printer section 300, and an operation unit 150. As shown in FIG. 1, the operation unit 150 is arranged on the front surface of the image processing apparatus 100. The control unit 110 provides a copy function by controlling the reader section 200 to read document image data and controlling the printer section 300 to output the image data on printing paper. The control unit 110 also provides a scanner function of converting image data read by the reader section 200 into code data, and transmitting the code data to a host computer (not shown) via the LAN. Further, the control unit 110 provides a printer function of converting code data received from the host computer via the LAN into image data, and outputting the image data to the printer section 300.

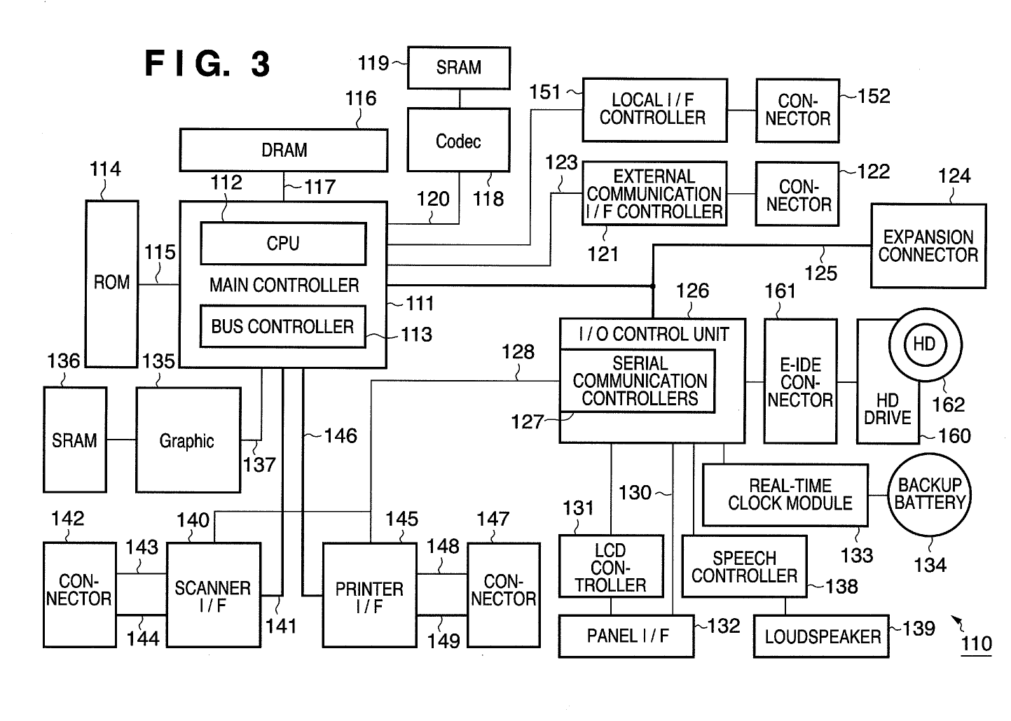

FIG. 3 is a block diagram showing the hardware configuration of the control unit 110.

A main controller 111 mainly comprises a CPU 112, a bus controller 113, and a variety of interface controller circuits (not shown) (an “interface” will be simply referred to as an “I/F” hereinafter).

The CPU 112 and bus controller 113 control the operation of the whole control unit 110. The CPU 112 operates on the basis of a program loaded from a ROM 114 via a ROM I/F 115. This program also describes an operation to interpret PDL (Page Description Language) code data received from a host computer and rasterize it into raster image data. This program is processed by software. The bus controller 113 controls transfer of data input/output from/to I/Fs, and performs arbitration of bus conflict and transfer control of DMA data.

A DRAM 116 is connected to the main controller 111 via a DRAM I/F 117, and serves as a work area for the operation of the CPU 112 and an area for accumulating image data.

A Codec 118 compresses raster image data accumulated in the DRAM 116 by a format such as MH/MR/MMR/JBIG/JPEG, and decompresses compressed/accumulated code data into raster image data. An SRAM 119 serves as a temporary work area for the Codec 118. The Codec 118 is connected to the main controller 111 via an I/F 120. The bus controller 113 controls data transfer between the Codec 118 and the DRAM 116 to DMA-transfer the data.

A graphic processor 135 performs processes such as image rotation, scaling, and color space conversion. An SRAM 136 serves as a temporary work area for the graphic processor 135. The graphic processor 135 is connected to the main controller 111 via an I/F 137, and the bus controller 113 controls data transfer from the I/F 137 to the DRAM 116.

An external communication I/F 121 connects a connector 122 to the main controller 111, and the connector 122 connects the main controller 111 to the LAN. A local I/F controller 151 connects a connector 152 to the main controller 111, and the connector 152 can connect a local I/F.

A general-purpose high-speed bus 125 connects an I/O control unit 126 to an expansion connector 124 for connecting an expansion board. An example of the general-purpose high-speed bus is a PCI bus.

The I/O control unit 126 comprises asynchronous serial communication controllers 127 of two channels for transmitting/receiving control commands to/from the CPUs of the reader section 200 and printer section 300. An I/O bus 128 connects the asynchronous serial communication controllers 127 to a scanner I/F 140 and printer I/F 145, respectively.

A panel I/F 132 is connected to an LCD controller 131, and comprises an I/F for display on the liquid crystal screen of the operation unit 150 and a key input I/F 130 for inputs from hard keys and touch panel keys.

A real-time clock module 133 updates and saves a date and time managed inside the apparatus, and is backed up by a backup battery 134.

A speech controller 138 outputs, from a loudspeaker 139, a voice message corresponding to an input operation to the operation unit 150.

An E-IDE connector 161 connects an external storage device. In the embodiment, a hard disk drive 160 is connected via the connector 161 to perform communication when storing image data in a hard disk 162 or reading out image data from the hard disk 162.

Connectors 142 and 147 connect the reader section 200 and printer section 300, respectively. The connector 142 is connected to the scanner I/F 140 via an asynchronous serial I/F 143 and video I/F 144. The connector 147 is connected to the printer I/F 145 via an asynchronous serial I/F 148 and video I/F 149.

A scanner bus 141 connects the scanner I/F 140 to the main controller 111. With this arrangement, the scanner I/F 140 has a function of performing a predetermined process for an image received from the reader section 200, and a function of outputting, to the scanner bus 141, a control signal generated on the basis of a video control signal sent from the reader section 200.

The bus controller 113 controls data transfer from the scanner bus 141 to the DRAM 116.

A printer bus 146 connects the printer I/F 145 to the main controller 111. With this arrangement, the printer I/F 145 has a function of performing a predetermined process for image data output from the main controller 111 and outputting the processed data to the printer section 300. The printer I/F 145 also has a function of outputting to the printer bus 146 a control signal generated on the basis of a video control signal sent from the printer section 300.

The bus controller 113 controls transfer of raster image data rasterized in the DRAM 116 to the printer section 300, and DMA-transfers the raster image data to the printer section 300 via the printer bus 146 and video I/F 149.

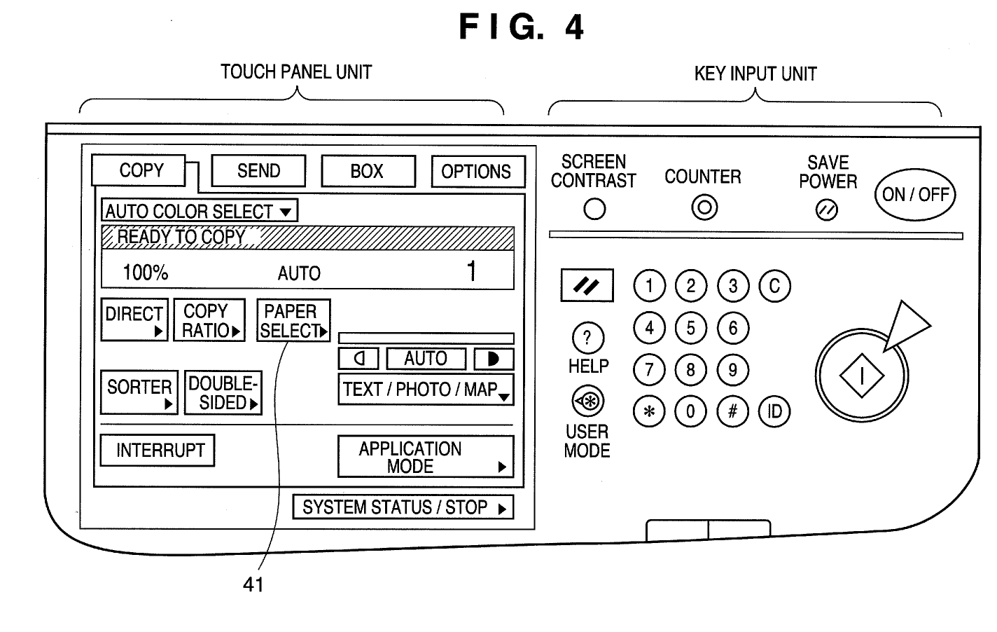

FIG. 4 is a view showing an arrangement of the operation unit 150. As shown in FIG. 4, the operation unit 150 in the embodiment comprises a touch panel unit made up of an LCD (Liquid Crystal Display) and a transparent electrode adhered onto it, and a key input unit having a plurality of hard keys including a ten-key pad. The LCD controller 131 is programmed to, when the user touches with his finger a transparent electrode corresponding to a key on the touch panel unit, detect it and display another operation window. A signal input from the touch panel or hard key is transmitted to the CPU 112 via the panel I/F 132. The liquid crystal display displays image data sent from the panel I/F 132. The liquid crystal display displays functions, image data, and the like associated with the operation of the image processing apparatus 100.

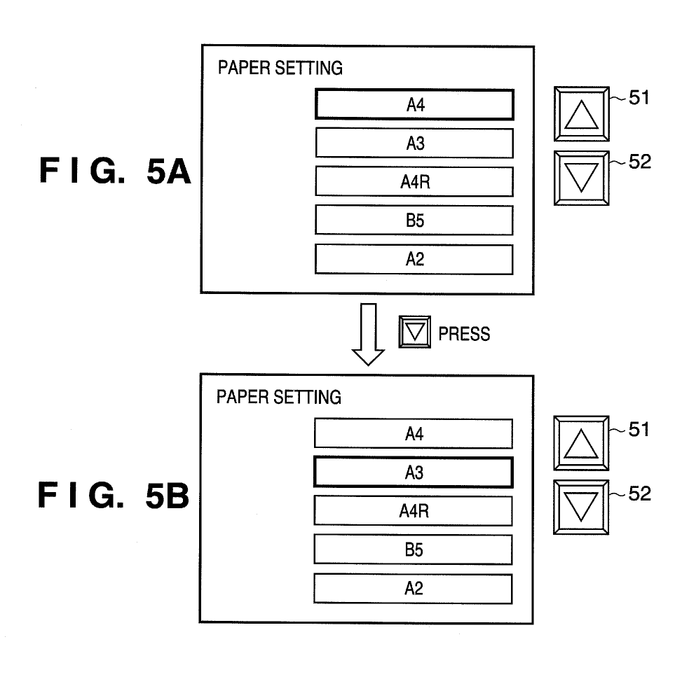

The operation window displayed on the touch panel unit of FIG. 4 is an example of an initial window in the standby mode. The touch panel unit displays various operation windows in accordance with setting operations. For example, when the user presses a paper select key 41, the LCD controller 131 displays a paper setting window as shown in FIG. 5A.

In the state of FIG. 5A, the paper size “A4” has the focus. The user can move up or down the focus by pressing an up arrow button 51 or down arrow button 52. The speech controller 138 outputs, from the loudspeaker 139, a voice message concerning an item after moving the focus. For example, when the user presses the down arrow button 52 in the state of FIG. 5A, the LCD controller 131 moves the focus to the paper size “A3” as shown in FIG. 5B. In response to this, the speech controller 138 outputs a voice message “paper is set to A3.”

According to the embodiment, if the user performs a new operation during speech output, the speech output stops. For example, when the user presses the down arrow button 52 while “paper is set to A4.” is output, the speech controller 138 stops the speech output in progress. After the focus moves to “A3”, the speech controller 138 outputs a voice message “paper is set to A3.” In this case, the user hears “paper is set to A4, paper is set to A3.”

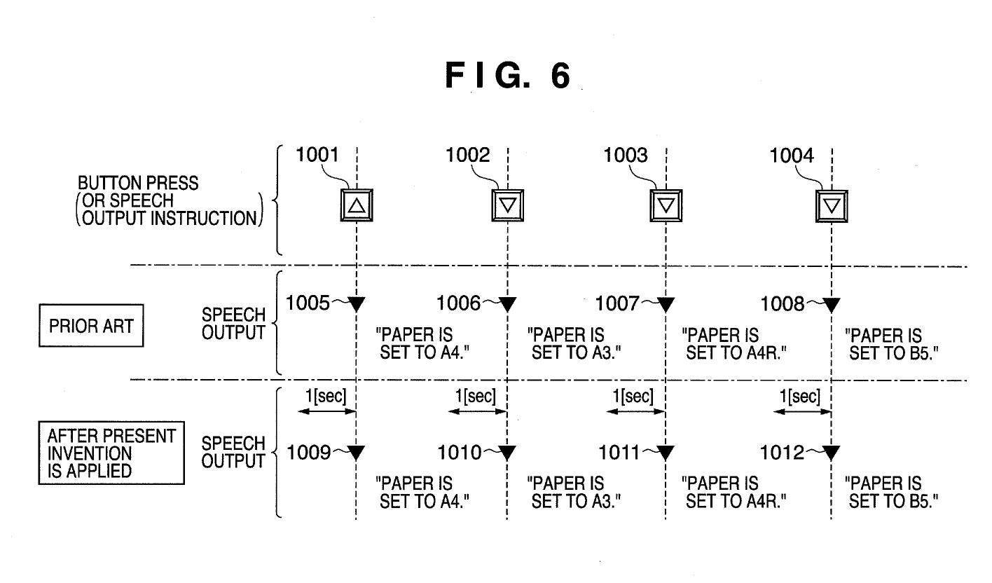

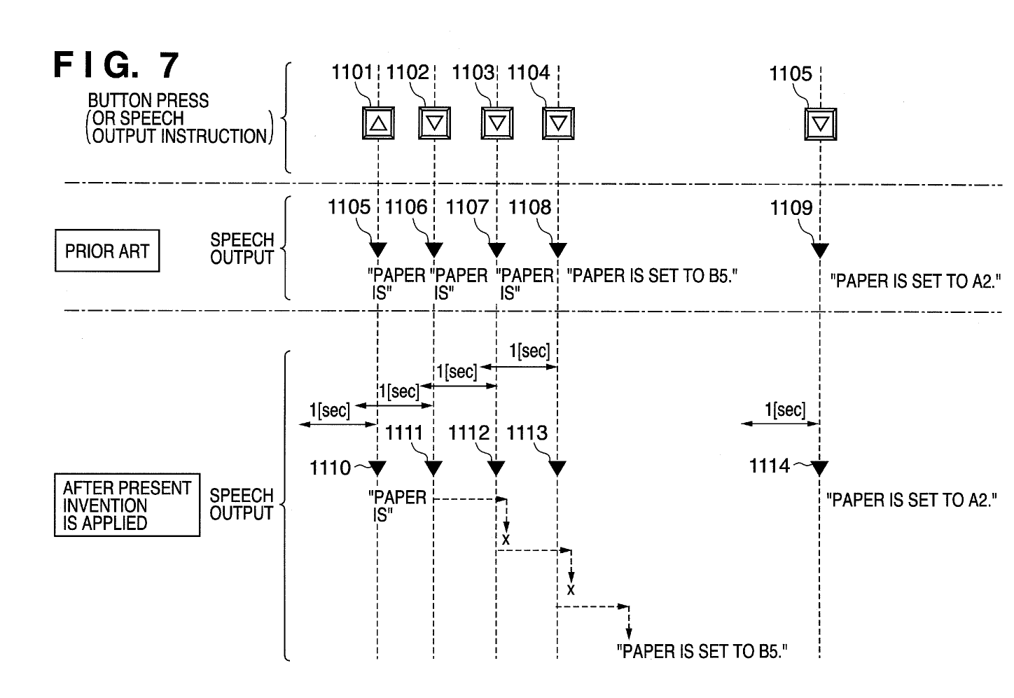

Concrete examples of this will be explained with reference to FIGS. 6 and 7. Each of these drawings shows a conventional operation example and an operation according to the embodiment.

An example of FIG. 6 will be described first. Reference numerals 1001 to 1004 denote presses of the up arrow button 51 or down arrow button 52 (to be simply referred to as “button presses” hereinafter). The interval between button presses is longer than the voice message output time length.

In the conventional operation example of FIG. 6, when the first button press 1001 is detected, the focus shifts to “A4”, and a voice message 1005 “paper is set to A4.” Operations upon the subsequent button presses 1002, 1003, and 1004 are the same as that upon the button press 1001. In this example, the interval between button presses is longer than the speech output time of the voice message “paper is set to . . . . ” Thus, the voice message does not stop during speech output.

An operation example in the embodiment will be described. When the I/O control unit 126 detects the first button press 1001, the LCD controller 131 shifts the focus to “A4”. The speech controller 138 determines that the button press 1001 is not a successive one, and quickly outputs a voice message 1009 “paper is set to A4.” In the embodiment, “whether the button press is a successive one” is determined from whether a specific number (e.g., 2) or more of button presses have been done within past 1 sec. However, the present invention is not limited to this determination condition, and may also employ another condition. Another example is “whether the button is kept pressed for a predetermined time or longer.” This condition may be set in advance in the system, or calculated from the past user input timing and dynamically changed.

Operations upon the remaining button presses 1002, 1003, and 1004 are the same as that upon the button press 1001. In this example, the interval between button presses is longer than the speech output time of the voice message “paper is set to . . . . ” Hence, the voice message does not stop during speech output. That is, in the example of FIG. 6, the speech output result is the same between the conventional example and the embodiment. Each voice message is entirely output immediately after button press.

FIG. 7 shows an example in which the user performs button presses 1101 to 1105. In this example, each of the intervals between the button presses 1101 to 1104 is shorter than the voice message output time length, and the interval between the button presses 1104 and 1105 is longer than the voice message output time length.

In the conventional operation example of FIG. 7, when the first button press 1101 is detected, the focus shifts to “A4”, and a voice message 1105 “paper is set to A4.” is output along with the shift. Operations upon the subsequent button presses 1102, 1103, 1104, and 1105 are basically the same as that upon the button press 1101. However, the voice message is being output upon each of the button presses 1102, 1103, and 1104, so the focus shifts after stopping the voice message. In this case, upon the button presses 1101, 1102, 1103, and 1104, the user hears “paper is, paper is, paper is, paper is set to B5.”

An operation example in the embodiment will be described. When the I/O control unit 126 detects the first button press 1101, the LCD controller 131 shifts the focus to “A4”. The speech controller 138 determines that the button press 1101 is not a successive one, and quickly outputs a voice message 1110 “paper is set to A4.”

When the I/O control unit 126 detects the next button press 1102, the LCD controller 131 shifts the focus to “A3”. The speech controller 138 determines that the button press 1102 is successive to the first button press 1101. Then, the speech controller 138 stops the voice message 1110 during output, and delays the start of a voice message 1111 corresponding to the button press 1102 by a predetermined time (e.g., 1 sec). The delay time may be fixed, or calculated on the basis of the interval between button presses by the user (e.g., if the button press interval is 0.5 sec, the voice message is output after 0.6 sec including a 0.1-sec delay.)

When the I/O control unit 126 detects the next button press 1103, the LCD controller 131 shifts the focus to “A4R′”. The speech controller 138 determines that the button press 1103 is successive to the previous button press 1102. Then, the speech controller 138 cancels programmed output of the voice message 1111, and delays the start of a voice message 1112 corresponding to the button press 1103 by a predetermined time (e.g., 1 sec).

An operation upon detecting the subsequent button press 1104 is also the same as that upon detecting the button press 1103.

In this example, the interval between the button press 1104 and the subsequent button press 1105 is longer than the voice message output time length. Upon the lapse of a predetermined time without detecting the next button press after detecting the button press 1104, the user hears a voice message “paper is . . . (interval of about 3 sec) . . . paper is set to B5.” The speech controller 138 can output a voice message the user can catch more clearly than a voice message “paper is, paper is, paper is set to B5.” as described in the conventional operation example.

An operation when the I/O control unit 126 detects the final button press 1105 is the same as that when it detects the first button press 1101. In this case, the speech controller 138 determines that the button press 1105 is not a successive one, and quickly outputs a voice message 1114 “paper is set to A2.” corresponding to the button press 1105.

In the above-described operation example, when it is determined that the button press is a successive one, the speech output start time is delayed. However, the present invention is not limited to this. As another example, the speech output may temporarily stop and after the lapse of a predetermined time, start again. Alternatively, a voice message may be output at a low volume and after the lapse of a predetermined time, return to an original volume.

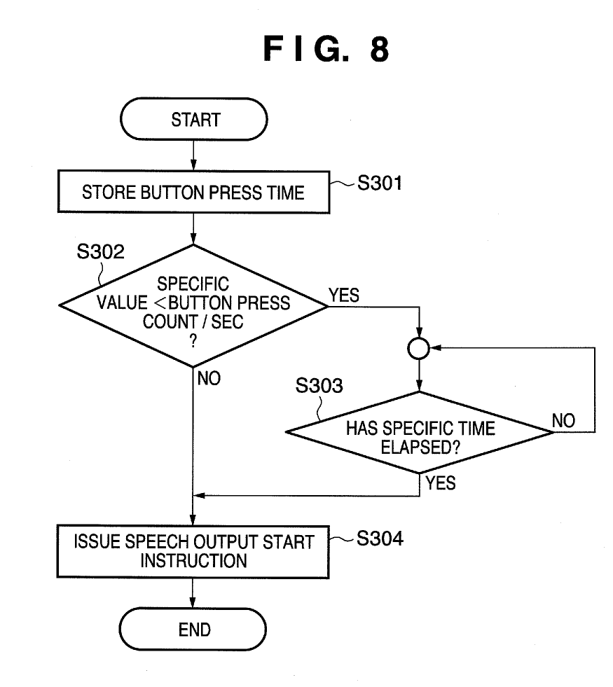

FIG. 8 is a flowchart showing a speech output control process by the speech controller 138 in the embodiment.

When the I/O control unit 126 detects a button press, the speech controller 138 uses the real-time clock module 133 to acquire and store the time when the button was pressed (step S301). In step S302, the speech controller 138 determines whether this button press is successive to a previous one. For example, when a specific number (e.g., 2) or more of button presses have been done within past 1 sec, the speech controller 138 determines that the button press is a successive one. If the speech controller 138 determines that the button press is not a successive one (NO in step S302), it quickly outputs, from the loudspeaker 139, a voice message corresponding to the button press detected in step S301 (step S304). If the speech controller 138 determines that the button press is a successive one (YES in step S302), it outputs a voice message corresponding to the button press detected in step S301 (step S304) after the lapse of a specific time (YES in step S303).

(First Modification)

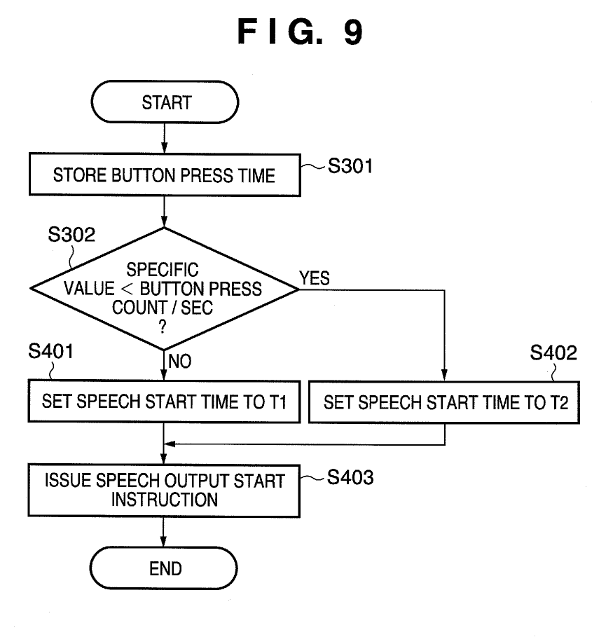

FIG. 9 shows the first modification of the speech output control process shown in FIG. 8.

When the I/O control unit 126 detects a button press, the speech controller 138 uses the real-time clock module 133 to acquire and store the time when the button was pressed (step 5301). In step S302, the speech controller 138 determines whether this button press is successive to a previous one. If the speech controller 138 determines that the button press is not a successive one (NO in step S302), it sets the speech output start time to T1 (step S401), and outputs a voice message at time T1 (step S403). If the speech controller 138 determines that the button press is a successive one (YES in step S302), it sets the speech output start time to T2 (T2 is later than T1) (step S402), and outputs a voice message at time T2 (step S403).

In this example, the speech output start time is set. However, the present invention is not limited to this, and the time till speech output may be set. In this case, the time T2 set in step S402 is longer the time T1 set in step S401, or T1=0.

(Second Modification)

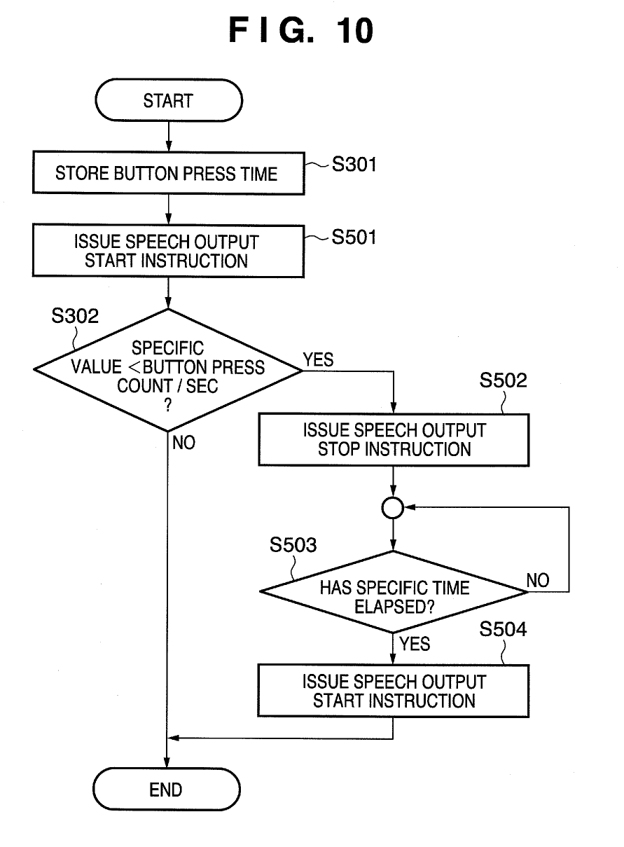

FIG. 10 shows the second modification of the speech output control process shown in FIG. 8.

When the I/O control unit 126 detects a button press, the speech controller 138 uses the real-time clock module 133 to store the time when the button was pressed (step S301). In addition, the speech controller 138 issues a speech output start instruction (step S501). In step S302, the speech controller 138 determines whether this button press is successive to a previous one. If the speech controller 138 determines that the button press is not a successive one (NO in step S302), the process ends. If the speech controller 138 determines that the button press is a successive one (YES in step S302), it issues a speech output stop instruction (step S502). After the lapse of a specific time (e.g., 1 sec) (YES in step S503), the speech controller 138 issues a speech output start instruction again (step S504). At this time, output of the voice message starts from the beginning again.

(Third Modification)

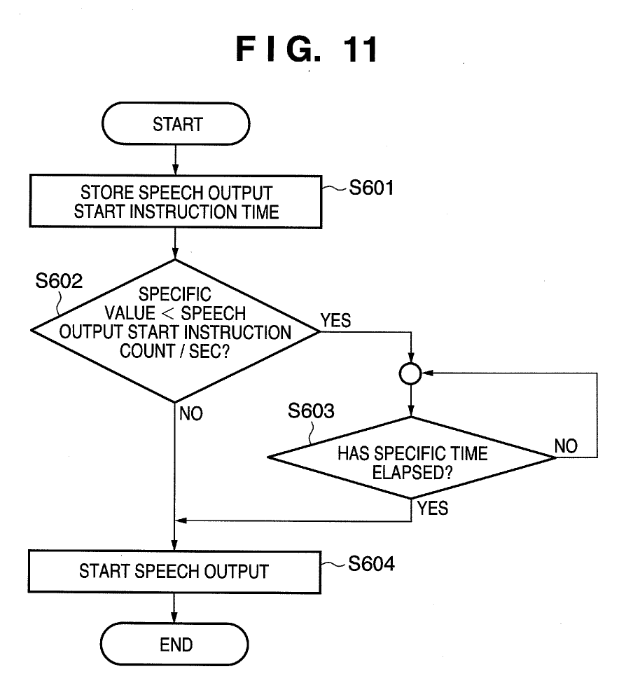

FIG. 11 shows the third modification of the speech output control process shown in FIG. 8.

In the above-described embodiment, the speech controller 138 controls speech output on the basis of whether buttons have successively been pressed. To the contrary, in the following description, the speech controller 138 issues a speech output instruction immediately after detecting a button press. The speech controller 138 controls speech output on the basis of whether speech output instructions have successively been issued. An operation example of this system when viewed from the user is the same as those in FIGS. 6 and 7. In this case, reference numerals 1001 to 1004 in FIG. 6 and reference numerals 1101 to 1105 in FIG. 7 denote not button presses but speech output instruction timings.

In FIG. 11, after issuing a speech output start instruction, the speech controller 138 uses the real-time clock module 133 to acquire and store the time when the instruction was issued (step S601). In step S602, the speech controller 138 determines whether this speech output start instruction has been issued successively to a previous one. For example, when a specific number (e.g., 2) or more of speech output start instructions have been issued within past 1 sec, the speech controller 138 determines that a speech output start instruction has successively been issued. If the speech controller 138 determines that no speech output start instruction has successively been issued (NO in step S602), it quickly outputs, from the loudspeaker 139, a voice message corresponding to the speech output start instruction issued in step S601 (step S604). If the speech controller 138 determines that the speech output start instruction has successively been issued (YES in step S602), it outputs a voice message corresponding to the speech output start instruction issued in step S601 (step S604) after the lapse of a specific time (YES in step S603).

(Fourth Modification)

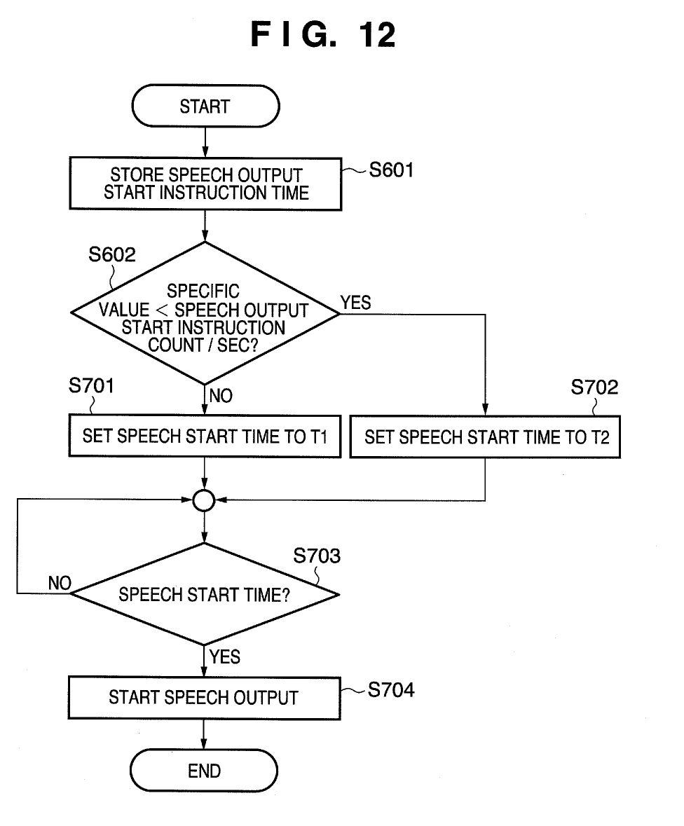

FIG. 12 shows a modification of the speech output control process shown in FIG. 11, and corresponds to the example shown in FIG. 9.

After issuing a speech output start instruction, the speech controller 138 uses the real-time clock module 133 to acquire and store the time when the instruction was issued (step S601). In step S602, the speech controller 138 determines whether this speech output start instruction has been issued successively to a previous one. If the speech controller 138 determines that no speech output start instruction has successively been issued (NO in step S602), it sets the speech output start time to T1 (step S701). If the speech controller 138 determines that the speech output start instruction has successively been issued (YES in step S602), it sets the speech output start time to T2 (T2 is later than T1) (step S702). At the set speech output start time (YES in step S703), the speech controller 138 outputs a voice message corresponding to the speech output start instruction issued in step S601 (step S704).

(Fifth Modification)

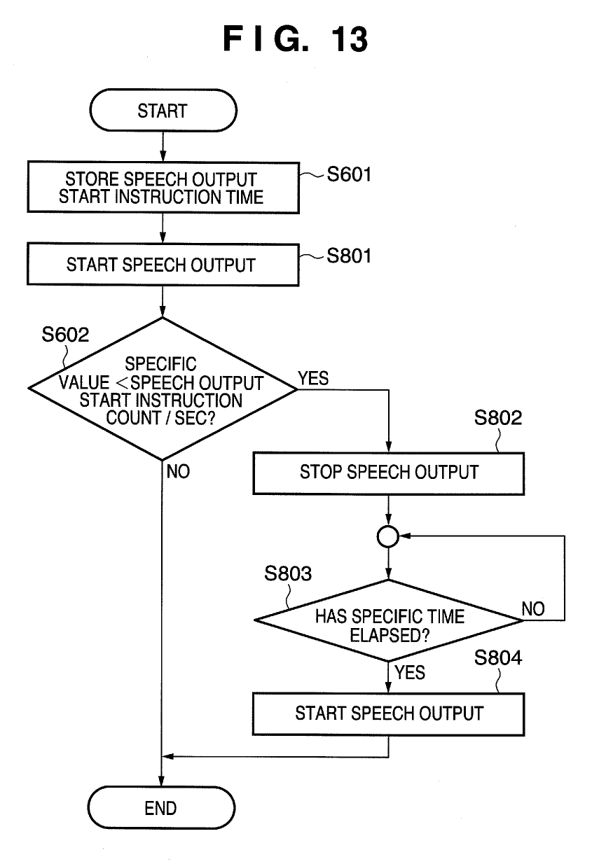

FIG. 13 shows another modification of the speech output control process shown in FIG. 11, and corresponds to the example shown in FIG. 10.

After issuing a speech output start instruction, the speech controller 138 uses the real-time clock module 133 to acquire and store the time when the instruction was issued (step S601). Then, the speech controller 138 starts speech output (step S801). In step S602, the speech controller 138 determines whether this speech output start instruction has been issued successively to a previous one. If the speech controller 138 determines that no speech output start instruction has successively been issued (NO in step S602), the process ends. If the speech controller 138 determines that the speech output start instruction has successively been issued (YES in step S602), it issues a speech output stop instruction (step S802). After the lapse of a specific time (e.g., 1 sec) (YES in step S803), the speech controller 138 issues a speech output start instruction again (step S804). At this time, output of the voice message starts from the beginning again.

As described above, according to the embodiment, when the user successively performs input operations, no intermediate voice message is output. This prevents output of uncomfortable voice messages in pieces, improving user friendliness and comfortability.

In the above-described embodiment, the input operation support apparatus according to the present invention is applied to an image processing apparatus. However, the application range of the present invention is not limited to the image processing apparatus, and the present invention is applicable to various devices each having an operation unit.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code installed in the computer also implements the present invention. In other words, the claims of the present invention also cover a computer program for the purpose of implementing the functions of the present invention.

In this case, so long as the system or apparatus has the functions of the program, the program may be executed in any form, such as an object code, a program executed by an interpreter, or script data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

It is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Besides the cases where the aforementioned functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-246136, filed Sep. 11, 2006, which is hereby incorporated by reference herein in its entirety.

What is claimed is:

1. An input operation support apparatus having a speech output unit configured to output a voice message corresponding to an input operation to an operation unit, the apparatus comprising:
a detection unit configured to detect an input operation to the operation unit; and
a control unit configured to, when said detection unit detects a second input operation within a predetermined time after a first input operation, restrict output of a voice message corresponding to the second input operation from the speech output unit.

2. The apparatus according to claim 1, wherein when said detection unit does not detect a third input operation within a predetermined time after the second input operation, said control unit controls the speech output unit to output a voice message corresponding to the second input operation.

3. The apparatus according to claim 1, wherein the predetermined time is a time corresponding to an output time length of the voice message.

4. The apparatus according to claim 1, wherein when said detection unit detects the second input operation within the predetermined time after the first input operation, said control unit delays, by a specific time longer than the predetermined time, a start of output of the voice message corresponding to the second input operation from the speech output unit.

5. The apparatus according to claim 1, wherein when said detection unit detects the second input operation within the predetermined time after the first input operation, said control unit reduces output of a voice message corresponding to the first input operation from the speech output unit.

6. A method of controlling an input operation support apparatus having a speech output unit configured to output a voice message corresponding to an input operation to an operation unit, the method comprising:
a detection step of detecting an input operation to the operation unit; and
a control step of, when a second input operation is detected in the detection step within a predetermined time after a first input operation, restricting output of a voice message corresponding to the second input operation from the speech output unit.

7. A program stored on a computer-readable storage medium, to control an input operation support apparatus having a speech output unit configured to output a voice message corresponding to an input operation to an operation unit, the program comprising:
a code for a detection step of detecting an input operation to the operation unit; and
a code for a control step of, when a second input operation is detected in the detection step within a predetermined time after a first input operation, restricting output of a voice message corresponding to the second input operation from the speech output unit.
